(19) United States
(12) Patent Application Publication
(10) Pub. No.: US 2026/0205358 A1
(43) Pub. Date: Jul. 16, 2026

(54) APPARATUS AND METHOD FOR INTRODUCING A DATA PREPARATION CONFIGURATION POLICY

(71) Applicant: Lenovo (Singapore) Pte. Limited, Singapore (SG)

(72) Inventors: Konstantinos Samdanis, Munich (DE); Emmanouil Pateromichelakis, Viersen (DE)

(73) Assignee: Lenovo (Singapore) Pte. Limited, Singapore (SG)

(21) Appl. No.: 19/113,300

(22) PCT Filed: Nov. 10, 2022
(86) PCT No.: PCT/EP2022/081510

§ 371 Date: Mar. 19, 2025

(30) Foreign Application Priority Data
Oct. 3, 2022 (GR) 20220100809

(51) Int. Cl. H04L 41/0853; H04L 41/122; H04W 24/08

(52) U.S. Cl. CPC H04L 41/0853; H04L 41/122; H04W 24/08

(57) ABSTRACT

There is provided a data preparation service in a wireless communication network, the data preparation service arranged to: receive, via a network automation and/or optimization tool, configuration information from an application and/or service provider; and execute a configuration to control a data preparation process using the configuration information.

### FIELD

The subject matter disclosed herein relates generally to the field of data preparation. More specifically, the subject matter disclosed herein relates to the introduction of data preparation policies, in particular, in an Open Radio Access Network (O-RAN). This document defines a data preparation service and method performed thereby, and a service or application provider and method performed thereby.

### BACKGROUND

Network analytics and Artificial Intelligence (AI)/Machine learning (ML) is deployed in the O-RAN architecture. Various analytics types, that can be distinguished using different AI/ML Analytics services.

Each AI/ML analytics service may support one or more Analytics types and may have the role of implementing: (i) AI/ML inference, or (ii) AI/ML training, or (iii) both.

Currently, in the O-RAN architecture there is no consideration regarding the data preparation configuration from an application or service provider, which is the first step of analytics that significantly influences the analytics performance.

### SUMMARY

Disclosed herein are procedures for data preparation for analytics data in the O-RAN architecture. Also disclosed herein are a data preparation service arranged to perform said data preparation. Also disclosed herein is a configuration controller for controlling the operation of the data preparation service.

There is provided a data preparation service in a wireless communication network. The data preparation service is arranged to: receive, via a network automation and/or optimization tool, configuration information from an application and/or service provider; and execute a configuration to control a data preparation process using the configuration information.

There is further provided a method performed by a data preparation service in a wireless communication network. The method comprises: receiving, via a network automation and optimization tool, configuration information; and configuring a data preparation process using the received configuration information.

There is further provided a service or application provider in a wireless communication network. The service or application provider is configured to: generate configuration information for configuring a data preparation process of a data preparation service in the wireless communication network; and send, via a network automation and optimization tool, the configuration information to the data preparation service.

There is further provided a method performed by a service or application provider in a wireless communication network. The method comprises: generating configuration information for configuring a data preparation process of a data preparation service in the wireless communication network; and sending, via a network automation and optimization tool, the configuration information to the data preparation service.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for data preparation and control will now be described, by way of example only, with reference to the accompanying drawings, in which:

FIG. 1 depicts a wireless communication system;

FIG. 2 depicts a user equipment apparatus;

FIG. 3 depicts a network node;

FIG. 4 is a schematic illustration of a network, and illustrates various types of NWDAF;

FIG. 5 is a schematic illustration showing the O-RAN AI/ML General Procedures;

FIG. 6 is a schematic illustration illustrating a sequence of the operations related to data preparation;

FIG. 7 illustrates the O-RAN architecture;

FIG. 8 is a process flow chart showing a method of data preparation, as performed by an apparatus in the wireless communication system;

FIG. 9 is a process flow chart showing a method for introducing a data preparation policy into a data preparation service of an O-RAN; and

FIG. 10 is a process flow chart showing a method of generating and sending a data preparation policy.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

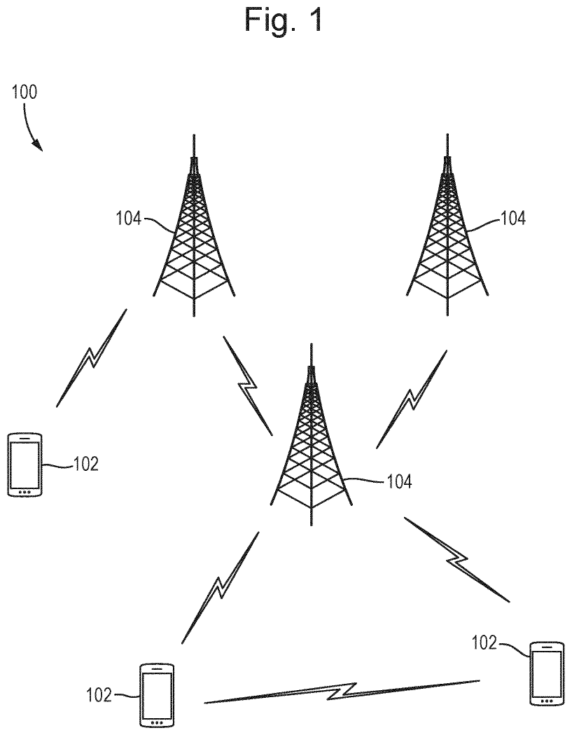

FIG. 1 depicts an embodiment of a wireless communication system 100 in which a data preparation method, a data preparation function, and a controller for the data preparation function may be implemented. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

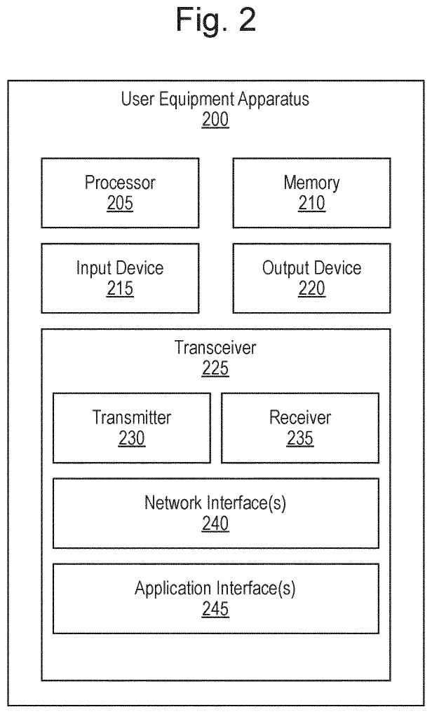

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be in accordance with or the same as the remote unit 102 of FIG. 1. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

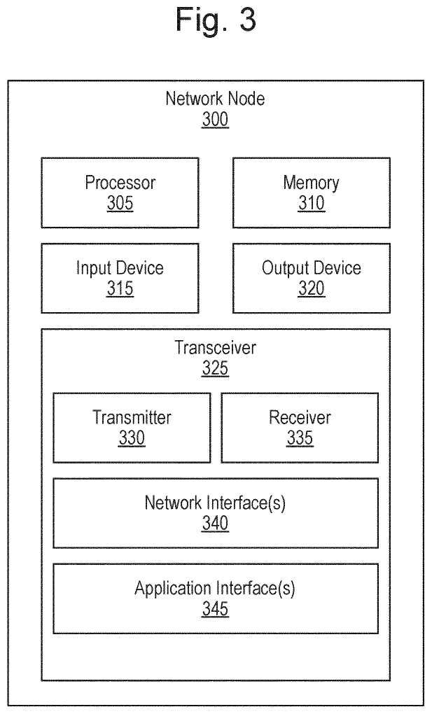

FIG. 3 depicts further details of the network node 300 that may be used for implementing the methods described herein. The network node 300 may be one implementation of an entity in the wireless communications network, e.g., in one or more of the wireless communications networks described herein, e.g., the wireless network 100 of FIG. 1. The network node 300 may be, for example, the UE apparatus 200 described above, or a Network Function (NF) or Application Function (AF), or another entity, of one or more of the wireless communications networks of embodiments described herein, e.g., the wireless network 100 of FIG. 1. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

The following information is useful in the understanding of the methods and apparatuses for data preparation for analytics data in the 3GPP architecture, which are described later below.

Currently, network analytics and AI/ML is deployed in the 5G core network via the NWDAF. Various analytics types may be supported. The various analytics types can be distinguished using different Analytics IDs, e.g., “UE Mobility”, “NF Load”, etc. This is discussed in TS 23.288. Each NWDAF may support one or more Analytics IDs and may have the role of: (i) AI/ML inference, called NWDAF AnLF; or (ii) AI/ML training, called NWDAF MTLF; or (iii) both.

NWDAF AnLF, or simply AnLF, and NWDAF MTLF, or simply MTLF, represent logical functions that can be deployed as standalone functions or in combination. AnLF that supports a specific Analytics ID inference using a AI/ML Model subscribes to a corresponding MTLF that is responsible for the training of the same AI/ML Model used for the respective Analytics ID.

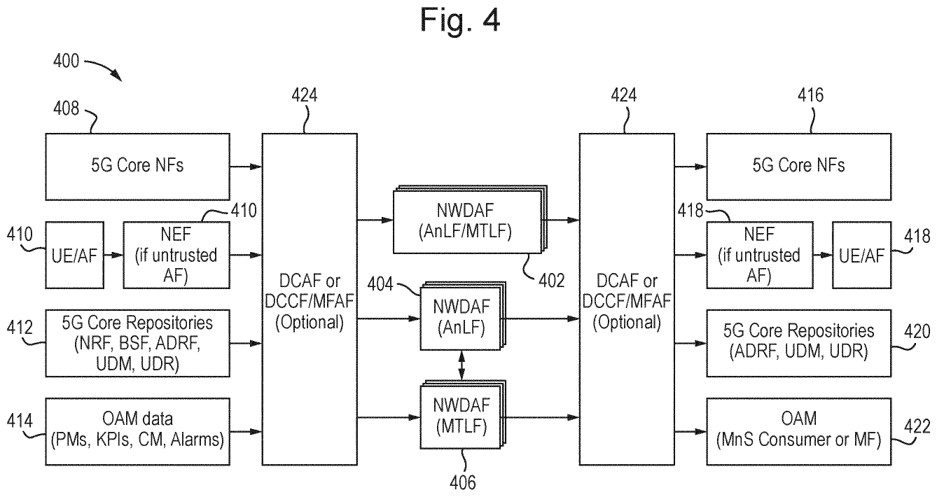

FIG. 4 is a schematic illustration of a network 400, and illustrates the various NWDAF “flavours” or types (specifically an NWDAF AnLF/MTLF 402, an NWDAF AnLF 404, and an NWDAF MTLF 406), and their respective input data and output result consumers. Specifically, an Analytics ID, contained in a NWDAF 402, 404, 406, relies on various sources of data input including data from 5G core NFs 408, AFs 410, 5G core repositories 412, e.g., Network Repository Function (NRF), UDM, etc., and OAM data 414, e.g., PMs/KPIs, CM data, alarms, etc. An Analytics ID contained in AnLF and may provide analytics output result towards 5G core NF 416, AF 418, 5G core repositories 420, e.g., UDM, UDR ADRF, or OAM MnS Consumer or MF 422. MTLF and AnLF may exchange AI/ML models, e.g., via the means of serialization, containerization, etc., including related model information. Optionally, a DCCF and MFAF 424 may be involved to distribute and collect repeated data towards or from various data sources.

Currently, in the 3GPP architecture there is no consideration regarding the data preparation, which is the first step of analytics that significantly influences the analytics performance. Data preparation may be considered to be an essential step in AI/ML model lifecycle and is the process of preparing raw data so that it is suitable for analytics. When employing AI/ML-enabled analytics, data preparation tends to be particularly important, since typically a variety of data is collected from different types of sources, which may include but are not limited to UEs, network functions, management entities, and application entities. Such data may be used for AI/ML model training and/or inference, and it is preferred that the quality of the data is optimal.

Data preparation is responsible for (i) understanding the characteristics of data, i.e., collecting information about the data, e.g., type of data, range, etc., (ii) determining if the data suffers from quality issues, e.g., errors or missing values, and dealing with them, and (iii) formatting and labelling data, preparing also the data set(s) for training purposes. Data preparation can pre-process raw data from the UE, network, and application sources into a data format that can feed both AI/ML model training and inference phases. Raw data sources may include the following types of data:
Numeric: values of real data that allow arithmetic operations
Interval: Values that allow ordering and subtraction, e.g., time windows.
Ordinal: Values that allow ordering but not arithmetic operations, e.g., Quality of Experience (QoS)—low, medium, high.
Boolean: Binary values, e.g., 0 and 1.
Categorical: Finite set of values that cannot be ordered or perform athematic operations, e.g., UE, MICO.
Textual: Free-form text data, e.g., name or identifier.

Data preparation is already considered in the O-RAN architecture (O-RAN.WG2.AIML-v01.03), but it is considered as implementation specific component, mentioning only some of its functionalities that include data inspection and data cleaning.

According to O-RAN, data preparation depends on the use case (i.e., analytics type) and AI/ML model architecture employed, and has an impact on the model performance.

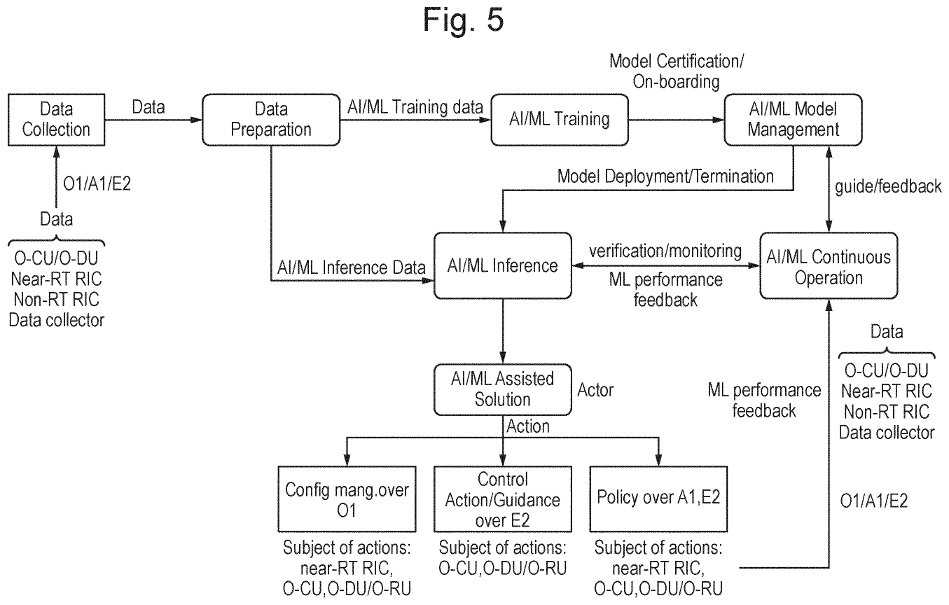

FIG. 5 is a schematic illustration showing the O-RAN AI/ML General Procedures, as specified in O-RAN.WG2.AIML-v01.03.

However, data preparation may require guidance on how to deal with low data quality issues. Such guidance may depend on, for example, the: i) analysis of the data characteristics, ii) the type of the AI/ML Model that uses the data, and/or iii) the availability of external tools or data sources. Also, the guidance may rely on input provided by 5G NFs, AFs including 3rd parties, and other network tools.

Implementation specific solutions may rely on pre-configured or “closed” mechanisms to deal with data preparation, or can be vendor specific. However, pre-configuration, “closed” or vendor specific solutions may fail to deal with unknown problems and may introduce overhead for preparing data that can be consumed only by specific analytic entities, which cannot be shared with other vendors. Data preparation may also span over the analytics training and analytics inference respectively, which can be deployed by different vendors. Thus, coordination of the configuration of data preparation may be needed and, if no dedicated functionality exists, such logic may need to be present at both analytics training and analytics inference. This tends to introduce a higher overhead. In addition, implementation specific solutions tend to limit the interaction with other tools, e.g., a digital twin or a sandbox, or the interaction with 5G NFs, AF from 3rd parties, and the OAM (which can be offered by a different administrative player). In summary, poor and inaccurate data preparation can lower the performance of the AI/ML, for example by introducing model drift, while a data preparation with open control can be tailored based on the type of data, on the use of data for a given analytics event, type of the consumer, and/or data source profile.

The notion of formatting and/or processing in the current 3GPP architecture is introduced via the DCCF/MFAF, which may be provided in requests by data consumers as described in clause 5A.4 in TS 23.288. When using the messaging framework, the DCCF sends the formatting and/or processing instructions to the messaging framework, so the MFAF may format and/or process the data before sending notifications to the data consumers or other notification endpoints.

Formatting determines when a notification is sent to the consumer, e.g., considering time of an event trigger. This process typically has nothing to do with converting the data into a shape or format useful for the AI/ML model.

On the other hand, the processing of instructions allows summarizing of notifications to reduce the volume of data reported to the data consumer. The processing results in the summarizing of information from multiple notifications into a common report.

The data processing/preparation methods and apparatuses described herein can take advantage of the current state of the art in preparing the data analysis for identifying data irregularities.

For performing data simplification, by aggregating data from different sources or by introducing a sampling rate to reduce data set if that is too big, e.g., random sampling to reduce the data, i.e., by a certain percentage, the data preparation methods and apparatuses described herein can take advantage of the existing procedures related to contents of analytics exposure as documented in clause 6.1.3 TS 23.288.

The notion of data preparation is also introduced in ITU-T Y.3172 (06/2019) as a pre-processor node or logical entity that is responsible for cleaning data, aggregating data, or performing any other pre-processing needed for the data to be in a suitable form so that the ML model can consume it. ITU-T Y.3172 discusses the ML-pipeline control, i.e., how to combine the pre-processor with other ML related entities.

However, introducing a data preparation entity including the respective configuration with standardized interfaces to control the date preparation, i.e., allowing access and interaction with other NFs, AFs, OAM, tools, and 3rd parties, is still an open issue. Such data preparation and control can provide data sharing among various analytics services and can enhance the solution options when data preparation is facing data quality issues.

This disclosure deals with the operations of data preparation that involve the pre-processing of raw data into a form that is ready to be used by the AI/ML model. Data preparation deals with two main types of data: continuous (i.e., data values as a function of time) and categorical (data that belongs to different categories or levels/states). It is the initial step in the network analytics and can include several different tasks such as loading of data from selected data sources, data analysis, data cleaning, data processing or modification and data augmentation. These tasks fall into the following main categories:
i) data collection and analysis to identify irregularities;
ii) data recovery and cleaning considering (a) systematic errors involving large data records from different data sources and/or (b) individual data errors due to random or processing errors;
iii) data formatting; and
iv) data labelling and separation into sets for accommodating different training tasks.

The data quality issues can be regulated for a particular Analytics type, AI/ML model, and/or for a specific, e.g., application (for QoE) or geographical area or user(s), for example by instructing the adoption of different algorithms/models, mechanisms, and tools to deal with data preparation, e.g., cleaning data, recovering missing data, formatting, labeling and dividing data into different groups for performing AI/ML model inference and/or training.

This disclosure further proposes a policy-based and/or control provision configuration method that allows 3rd parties to negotiate and/or provide configuration information on how the network (i.e., the O-RAN system) shall handle and deal with data quality issues during the data preparation phase. Specifically, a 3rd party may introduce an application or a network service, e.g., V2X or SON, which needs network data and/or application data to derive an insight (e.g., QoS sustainability in the case of V2X) or a network service algorithm (e.g., load balancing SON algorithm). Since the 3rd party is aware of the behavior of the offering network service or application, it tends to have better knowledge on the impact of the different data sources, e.g., on the performance of the AI/ML model. Hence, the 3rd party can participate effectively in the data preparation process, providing to the O-RAN system information relating to or specifying how to the O-RAN system shall handle data quality issues, in terms errors, deficiencies or missing data as well as data formatting.

The proposed configuration provision method, which is described in more detail later below, can be achieved once a service level agreement (SLA) is agreed between the O-RAN network operator and the 3rd party. Such an SLA may allow the 3rd party to control the data quality issues in the data preparation process by the means of:
(i) installing (e.g., into the DP service in the O-RAN system) an algorithm, model, function, etc. which may be used for data preparation;
(ii) a meta language (e.g., provided to the DP service in the O-RAN system) that assists to describe an algorithm, model, function, etc. which may be used for data preparation;
(iii) selecting a method (e.g., a data preparation method) out of a predefined list, and providing an indication of said selection (e.g., to the DP service in the O-RAN system); and/or
(iv) providing a pointer to an assisting tool, e.g., digital twin, which can help resolve data quality issues.

The data quality issues can be regulated for a particular analytics type or analytics service, AI/ML model, or for a specific application (e.g., for QoE), or geographical area, or given UE(s).

Data quality issues etc. may be controlled by instructing the DP to adopt different algorithms/models, mechanisms, and/or tools to deal with data preparation, e.g., cleaning data, recovering missing data, formatting, labelling data, and dividing data into different groups for performing AI/ML model inference and/or training.

Typically, the configuration or provision of a policy or control for the purpose of data preparation can be performed when a new analytics service, application or network service is selected by a 3rd party consumer, or upon a particular event trigger, e.g., the network conditions change significantly or a change from peak to off-peak due to a load increase/decrease.

The Data Preparation (DP) logic that can be a part of the AI/ML service in the O-RAN system may include at least one of the following operations:
1. An operation to select data set or records from certain data sources or type(s) of data source (allowing a good fix of data from different sources for completeness) as indicated in the received Analytics type, i.e., related to the analytics job. The selection of data sources or records may also be influenced by the expected waiting time indicated by the consumer.
2. An operation to analyse the data for information extraction regarding the:
   Central tendency and variation, i.e., what values shall be expected mostly and what would be the variation, e.g., extracting the data mean, variation, minimum, maximum, and other statistical properties included the distribution of data.
   Relative effect among variables or features, e.g., how the values of one variable or feature changes in relation with another.
   Amount of data adequate for the requested task (i.e., Analytics type).
3. A data exploration operation to identify if the collected data faces quality issues including:
   Anomalies due to errors in data source, i.e., faults or security incidents, or data transfer errors.
   Missing values: a) in terms of the percentage per feature (a feature may be an individual measurable property or characteristic of the data that feed an AI/ML algorithm, e.g., UE type, mobility type, etc.) or with respect to a specific value range, or other data conditions, and b) in terms of reasoning, e.g., integration errors or processing errors if data preparation needs to generate new values for usage of the AI/ML algorithm or indicate data unavailability from data sources.
   Irregular cardinality, where there is a need to check for: a) feature errors (e.g., different data sources may indicate the same feature using different names or IDs), b) impractical features, e.g., with value of 1 (i.e., a feature that is identified by the developer but has no practical meaning for the AI/ML algorithm), and c) data that concentrate only on a particular range.
   Outliers that characterize values far beyond the expected range considering values that are: a) valid, i.e., correct values, but very different from what expected, or b) invalid, i.e., incorrect noise values that are inserted due to an error.
4. Data processing carries out the instructions or configuration provided by the DP configuration service related to:
   Executing a method to augment, replace, or account for missing data, for example, considering the: a) indicated range, b) percentage and volume of missing data, c) a method for augmenting, replacing, or accounting for missing data, etc.
   Executing a policy to perform data cleaning to get rid of outliers and random errors, for example, by: i) removing data or ii) introduce a weight to reduce their impact of certain data.
   Optionally, indicating an expected performance impact on the AI/ML model in case input data from a particular source is still missing, i.e., even after interacting with DP configuration, due to incapability of the selected method to retrieve the data.
   Simplifying indicated data.
5. Data formatting carries out the instructions given by the DP configuration service to convert data into the appropriate shape or format needed by the AI/ML model.
6. Prepare data sets for inference, training, validation, and testing according to the instructions given by the DP configuration service.

Points 1-3 above relate to data analysis, while points 4-6 above relate to data processing.

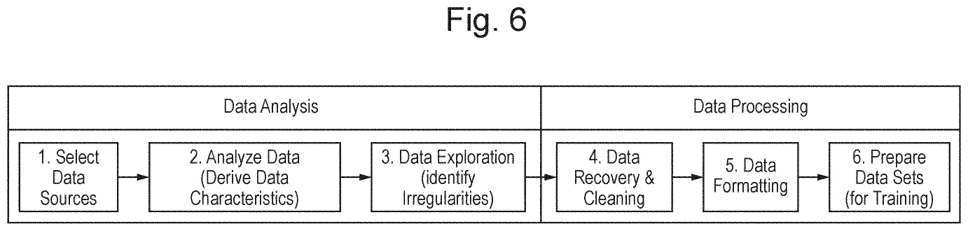

FIG. 6 is a schematic illustration illustrating a sequence of the operations related to the data preparation, corresponding to point 1-6 described in more detail above. Although FIG. 6 shows a certain sequence of steps, this sequence can be also differently executed, e.g., steps 4 and 5 can be reversed allowing the data processing first before the data recovery and cleaning.

The 3^{rd} party that is responsible for configuring the data preparation processes can introduce, into the DP service, e.g. via the means of a network automation and/or optimization tool (i.e., an APP) in O-RAN, at least one of the following operations:
Data recovery and cleaning to suggest the type of method to re-create data or delete data, including operations to:
   Determine the method to augment missing data considering the percentage and reasoning of missing data using at least one of the following methods:
      re-collecting data from the same or different data sources,
      deriving/producing new data via specific simulation tools (e.g., digital twin that can simulate a network environment to collect the missing data from the corresponding sources),
      null/mode/median value replacement considering neighbor values,
      interpolation—determining a value from the existing values, i.e., by inserting or interjecting an intermediate value between two other values,
      extrapolation—determining a value from values that fall outside a particular data set based on, e.g., curve's trajectory or the nature of the sequence of known values,
      forward filling/backward filling using the first or last value to fill the missing ones,
      multiple imputation considering the uncertainty of missing data by creating several different plausible imputed data sets and appropriately combining results obtained from each of them,
      using a predictive model (i.e., model-based imputation) to estimate missing values, e.g., regression, K-nearest neighbors, etc.
   Suggest one or more policies to the DP to perform data cleaning to get rid of outliers and random errors e.g., by introducing minimum and/or maximum thresholds, or by comparing the distance between mean, and 1st quartile and/or 3rd quartile and/or via other statistical means to:
      remove/delete data values characterized as outliers;
      introduce one or more weights to reduce the impact of outliers on the AI/ML algorithm.
   Suggest simplifying data e.g., by deleting data related to certain AI/ML features, i.e., if the collected data is very little, e.g., if 60% of data is missing, or simplify redundant features.
Data formatting including the selection of data sources, converting data into the appropriate shape or format, and suggesting the DP to use at least one of the following:
   Sort data, i.e., pre-sort data into a particular order.
   Aggregation to merge data from selected sources, optionally using a different weight for each data source or a different sample rate per data source, to control the impact of different sources.
   Dimensionality reduction to combine or relate different types of data.
   Normalization to change a continuous data to fall into a particular range maintaining the relative distance between the values.
   Binning to convert one category of data to another, e.g., convert continuous data into categorical or discretize data or convert categorical text data to categorical number data.
   Sampling to reduce data set if that is too big, e.g., random sampling or sampling using a specific function.
Dividing/splitting or preparing non-overlapping data sets, including labelling into inference data, training data, validation data, and testing data. This may include formulating sets considering volume per usage (i.e., typically validation and testing include 10-20% of the available data) and creating a strategy into the type of data inserted in each set, e.g., more recent data to be used for validation/testing. This step may also include the labelling of data, which may involve characterizing data for use in the AI/ML model.

It shall be appreciated by those skilled in the art that the methods suggested in relation with augmenting, cleaning, formatting, and diving data are just examples and that other methods that perform similar processes can be adopted instead of or in addition to those mentioned above.

In some embodiments, for example in the case of the O-RAN, the DP configuration information can be provided to the DP, via a network automation and/or optimization tool (i.e., via an xApp or an rApp) e.g., from a 3rd party which may be outside the O-RAM. The configuration information may be provided to the DP via xApp or an rApp depending on the deployment of the AI/ML model either in the near real-time (RT) or non-RT Radio Access Network (RAN) Intelligent Controller (RIC).

The following definitions are useful in the understanding of embodiments described herein:

The term “non-RT RIC” may refer to a logical function that enables non-real-time control and optimization of RAN elements and resources, AI/ML workflow including model training and updates, and policy-based guidance of applications/features in Non-RT RIC as well as supporting the Data Management Exposure Function. The R1 interface is an interface between an rApp and the functionality of the Non-RT RIC and SMO.

The term “near-RT RIC” (and framework functions) may refer to be a logical function that enables near-real-time control and optimization of RAN elements and resources via fine-grained (e.g., UE basis, Cell basis) data collection and actions over the E2 interface. Near-RT RIC comprises near-RT RIC basic/framework functions, which can include, for example, subscription management, conflict mitigation, etc.

The term “xApp” may refer to an application designed to run on the near-RT RIC. Such an application is likely to consist of one or more microservices and at the point of on-boarding may identify which data it needs to consume and which type of data it will provide as output. The application may be independent of the near-RT RIC and may be provided by any third party. The E2 interface enables a direct association between the xApp and the RAN functionality.

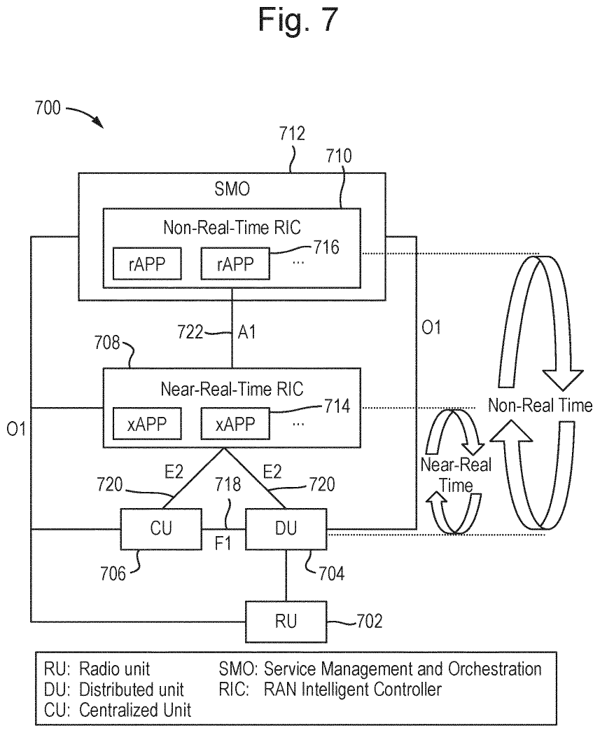

The term “rApp” may refer to an application designed to run on the non-RT RIC to realize different RAN automation and management use cases, with control loops on a time scale of one second and longer. Typical uses of the rApp may include network deployment, network optimization, network healing, network automation and AI/ML. The xApp or rApp can support the different vendor solutions or a 3rd party to introduce flexible a data preparation operation in relation with specific analytics as shown in FIG. 7.

FIG. 7 illustrates the O-RAN architecture 700, and the division of the RIC into near-RT RIC and non-RT RIC. As shown in FIG. 7, the O-Ran architecture 700 comprises a radio unit (RU) 702, a distributed unit (DU) 704, a central unit (CU) 706, a near-RT RIC 708, and a non-RT RIC 710 located in a service management and orchestration module 712. One or more xApp 714 is arranged to operate on the near-RT RIC 708. One or more rApp 716 is arranged to operate on the non-RT RIC 710. The RU 702 is operatively coupled or connected to the DU 704. The DU 704 is coupled or connected to the CU 706 via an F1 interface 718. The DU 704 and the CU 706 are coupled or connected to the near-RT RIC 708 via respective E2 interfaces 720. The near-RT RIC 708 is coupled or connected to the non-RT RIC 710 by an A1 interface 722. The rApp 716 and the non-RT RIC platform 702 are connected by the R1 interface (not shown in FIG. 7).

An xApp or rApp may allow the configuration of the DP by a 3rd party or different vendor to assist AI/ML model-based analytics or another network service or application. The configuration parameters (i.e., configuration information) can include the supporting library options for a specific service related to data recovery and cleaning, e.g., tools that can contact (e.g., digital twin), prediction models for estimating missing data, outlier policies including minimum-maximum values or weight values, and the methods to simplify and/or format data in order to be consumed by the respective AI/ML model.

What will now be described is the data Preparation for RAN analytics exposure.

In this embodiment, the role of the DP may be to support the use case of near real-time QoE optimization using RAN analytics exposure. An objective of this is to ensure that QoE optimization is supported by the O-RAN architecture and especially for Near-RT RIC and the E2 interface. Measurement data through E2 interface, e.g., cell level data, UE level data, can be acquired and processed via AI/ML algorithms to support, for example, traffic recognition, QoE prediction, QoS enforcement decisions, and the like. The analytics information, e.g., traffic rate, latency, packet loss rate, etc., can be further exposed to external applications to help applications execute logical control.

The entities and/or resources involved in this embodiment may include:
1) The near-RT RIC, which may be arranged to:
   a) Support receiving request or subscription messages from external applications, MEC, or a local NEF;
   b) Support receiving network state and UE performance report from RAN;
   c) Support data analysis and executing the AI/ML models to infer RAN analytics information, e.g., QoE prediction, and available bandwidth prediction;
   d) Support exposure RAN analytics information to Application Server/MEC/Local NEF; and/or
   e) Support the collection and use of policies/configurations from the Application Server/MEC/Local NEF from an app related to data preparation.
2) The RAN, which may be arranged to:
   a) Support network state and UE performance report with required granularity to the Near-RT RIC over the E2 interface;
3) An Application Server/MEC/Local NEF, which may be arranged to:
   a) Support request/subscribe to RAN analytics information from Near-RT RIC; and/or
   b) Create and provide policies/configurations related via an app related to data preparation to the near-RT RIC (e.g., to be used for RAN analytics derivation and AI/ML support function(s)).

The below Table 1 details RAN Performance Analytics assisted QoE Optimization.

TABLE 1
RAN Performance Analytics assisted QoE Optimization.

| | | |
|---|---|---|
| | | <<Uses>> |
| Use Case Stage | Evolution / Specification | Related use |

| | |
|---|---|
| Goal | Expose RAN analytics information to external applications, |
| | MEC or Local NEF. |
| Actors and Roles | Near-RT RIC, application server/MEC/Local NEF, E2 Nodes |
| Assumptions | All relevant functions and components are instantiated. |
| Pre conditions | QoE related models have been deployed in Near-RT RIC |
| | respectively. |
| Begins when | The application server, MEC or Local NEF wants to |
| | request/subscribe to RAN analytics information. |
| Step 1a (M) | Application server / MEC / Local NEF requests for RAN |
| | analytics information from Near-RT RIC. The request for |
| | RAN analytics information may be one-time or subscription- |
| | based (periodic or event triggered). |
| Step 1b (O) | Application server / MEC / Local NEF sends the data |
| | preparation configuration parameters per RAI event or RAI |
| | ID (together with the request/subscribe message or after) |
| Step 2 (M) | Near-RT RIC collects measurement data from E2 Nodes via |
| | RIC Subscription procedure. If data preparation is used at |
| | the AI/ML or RAN performance related RIC service, then |
| | near-RT RIC prepares the data based on the configuration |
| | received in step 1b. If data is missing, then at this step |
| | further data are requested from E2 nodes or SMO or DB at |
| | RIC side or the missing data is provided based on the |
| | method/algorithm provided in step 1b. Similarly, data |
| | clearness is performed and data formatting. |
| Step 3 (M) | Near-RT RIC generates the RAN analytics information, |
| | using QoE related AI/ML models and collected and |
| | processed measurement data as well as possible |
| | supplementary data based on the DP. |
| Step 4 (M) | Near-RT RIC sends the RAN analytics information to the |
| | application server, MEC or Local NEF. |
| Ends when | Application server, MEC or Local NEF receives the RAN |
| | analytics information. |
| Exceptions | FFS |
| Post Conditions | Application server executes logic control, e.g., TCP |
| | transmission window adjustment, video coding rate |
| | selection to improve QoE. |

What will now be described is the data preparation for RAN analytics exposure.

In this embodiment, RRM/SON xApps include a QoS optimization xApp, a Traffic Steering Optimization xApp, a RAN slice assurance xApp etc. These xApps provide some optimization of the RAN/UE resources. In this embodiment, the RRM/SON xApp or a dedicated authorized DP configuration xApp, sends the DP configuration for measurements/data collection and exposure to the near-RT RIC.

Without loss of generality, this embodiment can concentrate on the RAN slice and consider a use case with similar applicability to other SON paradigms. Network slicing is a prominent feature which provides end-to-end connectivity and data processing tailored to specific business requirements that may lead to customizable network capabilities in terms of data rates, traffic densities, service availability, latency, and reliability. These capabilities may be provided based on an SLA between the mobile operator and the business customer. O-RAN's open interfaces and AI/ML-based architecture tend to enable such challenging mechanisms to be implemented and help pave the way for operators to realize the opportunities of network slicing in an efficient manner.

The entities and/or resources involved in this embodiment may include:
1) The Non-RT RIC, which may be arranged to:
   a) Retrieve RAN slice SLA target from respective entities such as SMO, NSSMF.
   b) Perform long term monitoring of RAN slice performance measurements:
      i) Support data preparation that performs data enhancement, cleaning, formatting, labelling, and dividing data into training, validation and testing sets that are used for AI/ML training process that follows.
      ii) Receive or Fetch data preparation configuration considering algorithms, model description, policies, etc., provided via an rApp from a 3rd party interested in assuring SLA with customized network capabilities.
   c) Train potential AI/ML models that will be deployed in Non-RT RIC for slow loop optimization and/or Near-RT RIC for fast loop optimization.
   d) Support deployment and update of AI/ML models into Near-RT RIC.
   e) Receive slice control/slice SLA assurance rApps from SMO.
   f) Create and update of A1 policies based on RAN intent and A1 feedback.
   g) Send of A1 policies and enrichment information to Near-RT RIC to drive slice assurance.
   h) Send of O1 reconfiguration requests to SMO for slow-loop slice assurance
2) The Near-RT RIC, which may be arranged to:
   a) perform near real-time monitoring of slice specific RAN performance measurements.
   b) Support deployment and execution of the AI/ML models from Non-RT RIC including data preparation.
   c) Receive slice SLA assurance xApps from SMO.
      i) Receive data preparation xApp from a 3rd party.
   d) Support interpretation and execution of policies from Non-RT RIC.
   e) Perform optimized RAN (E2) actions to achieve RAN slice requirements based on O1 configuration, A1 policy, and E2 reports.
3) An E2 node, which may be arranged to:
   a) Support slice assurance actions such as slice-aware resource allocation, prioritization, etc. through E2.
   b) Support slice specific performance measurements through O1.
   c) Support slice specific performance reports through E2.

The below Table 2 details RAN Slice SLA assurance.

TABLE 2
RAN Slice SLA assurance

| | | |
|---|---|---|
| | | <<Uses>> |
| Use Case Stage | Evolution / Specification | Related use |

| | |
|---|---|
| Goal | RAN Slice SLA assurance |
| Actors and Roles | SMO Functions, Non-RT RIC Framework, Near-RT RIC, E2 |
| | Nodes |
| Assumptions | All relevant functions and components are instantiated. |
| | A1, O1, E2 interface connectivity is established. |
| Pre conditions | Near-RT RIC and Non-RT RIC are instantiated with A1 |
| | interface connectivity being established between them. |
| | O1 interfaces are established between SMO and Near-RT |
| | RIC, and SMO and E2 nodes. |
| | RAN slice SLA assurance applications have been deployed |
| | in Non-RT RIC and Near-RT RIC respectively. |
| Begins when | A RAN slice is activated or an operator defined trigger is |
| | detected |
| Step 1 (M) | OAM Functions may configure baseline Slice SLA Assurance |
| | parameters in E2 Node(s) through O1 interface. |
| | OAM Functions collects data from E2 node through O1 |
| | interface. |
| Step 2 (M) | RAN Slice SLA assurance rApp retrieves relevant information |
| | from Non-RT RIC Framework, such as active RAN slices |
| | (such as active S-NSSAIs, network slice subnet instances, |
| | topology), RAN Slice SLA information, NF configuration etc. |
| Step 3 (M) | RAN Slice SLA assurance rApp monitors and evaluates |
| | performance of RAN slices which may include detection of |
| | possible RAN Slice SLA violation. This step also includes rApp |
| | for configuring the data preparation. |
| Step 4 (M) | RAN Slice SLA assurance rApp decides to apply A1 policy |
| | based RAN slice SLA assurance considering RAN slice SLA |
| | requirements and/or operator-defined RAN intents, EI from |
| | external application servers and O1 based long term trends. |
| | In addition to these input parameters, A1 feedback from Near- |
| | RT RIC, when available, can be utilized for updating existing |
| | policies. |
| Step 5 (M) | (Start of Inner loop control) |
| | Near-RT RIC subscribes to a UE context information and |
| | measurement metrics via E2 interface. |
| | Near-RT RIC subscribes to xApp for configuring and/deriving |
| | the data preparation related to UE context information and |
| | related measurements. |
| Step 6 (M) | E2 Nodes report the UE context information and E2 |
| | measurements via RIC REPORT periodically or event- |
| | triggered. |
| Step 7 (M) | Near-RT RIC evaluates the performance data from E2 Nodes |
| | (including performance data from different E2 Nodes for the |
| | same UE), performs the data preparation and finds the |
| | performance is out of Slice SLA targets which are indicated in |
| | the A1 policy and/or internal near-RT RIC Slice SLA targets. |
| Step 8 (M) | Based on the UE context information, E2 measurement |
| | metrics (RIC REPORT), and A1 policy, Near-RT RIC may |
| | generate new or modify the existing E2 policies and sends |
| | them to E2 Nodes. |
| | Near-RT RIC may also generate control command(s) and |
| | send them to E2 Node(s) to trigger re-allocation of radio |
| | resources so that Slice SLA indicators can move back to the |
| | limits outlined in the A1 policies. |
| Step 9 (O) | Near RT-RIC may send A1 Policy feedback on A1 to the non |
| | RT-RIC. |
| Step 10 (O) | Non-RT RIC decides to delete Slice SLA Assurance policy and |
| | sends the related message or following internal trigger, the |
| | Near-RT RIC terminates the Slice SLA Assurance procedure. |
| Ends when | RAN slice(s) is deactivated or an operator defined trigger is |
| | detected |
| Exceptions | None identified |
| Post Conditions | SLA assurance for RAN Slice(s) over a period of time is |
| | achieved |
| Traceability | |

What will now be described is rApp/SMO Data Preparation.

In this embodiment, when registering for a data offer, the rApp provides the data preparation configuration (i.e., the configuration information) per rApp, or per data type ID, or per data event. The rApp may register as producer of data for a data type, and also include configuration parameters or the process to perform data preparation in terms of data enhancement, cleaning, and formatting. The Register data type procedures are defined as part of Data management and exposure services in R1 General Aspects and Principles.

The entities and/or resources involved in this embodiment may include:
1) Data management and exposure functions, which may be arranged to:
   a) Support functionality to allow an rApp to register and deregister as producer of data for a data type.
   b) Support functionality to allow an rApp to register the constraints for how it can produce and deliver data for the registered data type.
   c) Supports data preparation and validation of data type information (e.g., schema validation).
2) An rApp, which may be arranged to:
   a) Initiate the procedure to register and deregister as producer of data for a data type.
   b) Provide data preparation configuration.

The below Table 3 details data type registration.

TABLE 3
Data type registration

| | | |
|---|---|---|
| | | <<Uses>> |
| Use Case Stage | Evolution / Specification | Related use |

| | |
|---|---|
| Goal | The rApp registers as producer of data for a data type. |
| Actors and Roles | rApp in the role of Data registration and |
| | discovery service Consumer. |
| | Data management and exposure functions in |
| | the role of Data registration and discovery |
| | service Producer. |
| Assumptions | n/a |
| Preconditions | The rApp is authorized to access the Data |
| | management and exposure services. |
| | The rApp not registered as producer of data for |
| | the data type that they intend to register in Data |
| | management and exposure functions. |
| Begins when | The rApp determines the need to register as a producer |
| | of data for a data type. |
| Step 1 (M) | The rApp requests the Data management and exposure |
| | functions to register as producer of data for a data type |
| | by providing the rAppID and data type information. |
| Step 2 (M) | The Data management and exposure functions check |
| | with SME functions whether the rApp is authorized to |
| | register as producer of data. |
| Step 3 (M) | The Data management and exposure functions perform |
| | the data preparation and validate the data type |
| | information. |
| Step 4(M) | The Data management and exposure functions register |
| | the rApp as data producer of the data type. Further, in |
| | case this rApp is the first producer of data that registers |
| | for the data type, the Data management and exposure |
| | functions add the data type to the set of discoverable data |
| | types. |
| Step 5(M) | The Data management and exposure functions respond to |
| | rApp with successful data type registration along with |
| | data type registration identifier. |
| Ends when | The rApp was able to register as producer of data for a |
| | data type. |
| Exceptions | n/a |
| Post Conditions | The data type is discoverable. |
| Traceability | n/a |

In an embodiment, there is provided a data preparation service in a wireless communication network. The data preparation service comprises one or more processors arranged to: collect data from one or more data sources in the wireless communication network; analyse the collected data to derive one or more data characteristics and to identify whether the collected data face one or more quality issues or irregularities; and prepare the collected data based on the analysis. The preparing of the collected data comprises performing one or more of the following: data recovery to recover data missing from the collected data; data cleaning of the collected data; formatting of the collected data; or separation of the collected data into different data sets for one or more training tasks.

Deriving one or more data characteristics may comprise determining one or more data characteristics selected from the group of characteristics consisting of:
a central tendency of the collected data;
a variation of the collected data;
a relative effect among variables or features, e.g., how the values of one variable or feature changes in relation with another; and
an amount of data adequate for a requested task, e.g., a task associated with an Analytics type.

Identifying whether the collected data face one or more quality issues or irregularities may comprise identifying whether the collected data comprise one or more of the following:
an anomaly, e.g., due to errors in a data source such as faults, security incidents, or data transfer errors;
a missing value, e.g., in terms of the percentage per feature or with respect to a specific value range, or other data conditions, and/or in terms of reasoning, including integration errors or processing errors if data preparation needs to generate new values to allow usage of the AI/ML algorithm, or indicate data unavailability from data sources;
irregular cardinality, e.g. where there is a need to check for: a) feature errors (e.g., different data sources may indicate the same feature using different names or IDs), b) impractical features (e.g., with value of 1, and/or a feature that is identified by a developer but has no practical meaning for the AI/ML algorithm), and/or c) data that concentrate only on a particular range; or
an outlier, i.e., data that characterizes values beyond the expected range considering values that are: a) valid, i.e., correct values, but very different from what expected, or b) invalid, i.e., incorrect noise values that are inserted due to an error.

The data recovery may comprise one or more of the following:
recovering missing data from a different data source, i.e., a data source that is different to the initial data source from which that data was previously requested/attempted to be retrieved;
replacing the missing data by other data, which may be from the same or a different data source; and/or
augmenting existing data to account for the missing data.

The data recovery may comprise executing a method to augment missing data considering an indicated range and/or a percentage/volume of missing data.

The data cleaning may comprise executing a policy to mitigate against outliers and random errors from the collected data by removing data and/or introducing one or more weights to reduce the impact of outliers and random errors in the collected data.

The preparation of the collected data may comprises determining an expected performance impact and/or a confidence level on an AI/ML model were the prepared data used as an input for said AI/ML model. The performance impact and/or a confidence level may be determined, for example, in cases where input data from a particular data source is still missing, e.g., even after interacting with the DP configuration service, due to incapability of the selected method to retrieve the data.

The formatting of the collected data may comprise converting the collected data into an appropriate format used by an AI/ML model. This may be done by the DP service carrying out instructions provided to it by the DP configuration service.

The separation of the collected data into different data sets for one or more training tasks may further comprises the labeling and preparation of the data sets for inference, training, validation, and/or testing tasks. This may be performed in accordance with the instructions given by the DP configuration service.

Inference may use the set of all collected data once the data processing is performed. If the training data set comprises a relatively large percentage of the available data, e.g., 80%, or 70%, then the validation and testing data set may comprise 10% to 20% of the available data each, depending on the application. In some embodiments, data may be randomly allocated to a given set (i.e., training, validation, testing data sets).

In other embodiments, data may be allocated to specific sets based on a different set of criteria. In some embodiments, training of an AI/ML model is performed using a data set with values in a specific range; validation and testing of the trained model is then performed using data with values in a different range, to check that the training is acceptable.

The data preparation service may further comprise a receiver or interface arranged to receive a data preparation request. The one or more processors may be arranged to perform one or more of the data collection, data analysis, or data preparation, responsive to the data preparation request being received.

The receiver or interface may be arranged to receive the data preparation request from an AI/ML analytics service in the wireless communication network.

The data preparation request may comprise one or more attributes selected from the group of attributes consisting of:
an identifier for an analytics service, e.g., an Analytics type, that is to consume the prepared data;
an AI model that is to use the prepared data;
an ML model that is to use the prepared data;
time scheduling related to a time window of the prepared expected data;
one or more identifiers of the one or more data sources;
a type of data sources for the one or more data sources;
an expected waiting time bound for preparing the data. (When a request is issued, the source of the request may stipulate to the receiver that requested information/data is required within a specific timeframe, e.g., in the next 1 minute for example. In this case the waiting time bound for preparing the data would be 1 minute.);
one or more statistical properties of the prepared expected data, such as range, volume, distribution, etc.;
a Subscription Correlation identifier, which may be implemented, for example, in cases where the analytics request/data preparation request is modified;
an indication of the type of processing that the prepared data is expected to undergo when input into an AI/ML model, i.e., the expected processing of data as input to the AI/ML model, i.e., sorted data format, normalization, sampling rate to reduce the data, etc.;
a preferred level of accuracy for the prepared data, e.g., to deal with missing values or outliers; and
an indication of a format for the prepared data, e.g., an indication of a file and/or specific characteristics for the prepared data.

The data preparation service may further comprise a receiver arranged to receive control information related to the preparing of the collected data from a data preparation configuration service. The one or more processors may be arranged to prepare the collected data based on the received control information.

The one or more processors may be arranged to prepare the collected data based on control information provided by a data preparation configuration service. Thus, the control information and/or DP configuration service may control the data preparation processes of the data preparation service.

The control information may specify one or more of the following:
a data recovery and/or cleaning method to be implemented by the data preparation service;
a type of data recovery and/or cleaning method to be implemented by the data preparation service;
a type of data formatting that is to be used by the data preparation service to format the collected data;
the one or more data sources;
how to separate, divide, split, or prepare the collected data into data sets (e.g., non-overlapping data sets);
how to label data that are part of the data sets.

The data preparation service may further comprise a transmitter arranged to transmit a control request. Optionally, the control request may comprise one or more of:
an indication of the one or more data characteristics;
an indication of missing data values from the collected data;
an indication of outliers in the collected data;
an indication of a data simplification method; or
an indication of missing data labels for characterizing the data.

The data preparation service may further comprise a receiver arranged to receive control information. The control information may be received in response to the control request. Optionally, the control information may be comprising one or more of:
an indication of a type of problem with which the control information is concerned, such as missing data values, outliers, etc.;
an indication or specification of a strategy or method for handling the missing data values indicated in the control request;
an indication or specification of a strategy or method for handling the outliers indicated in the control request;
an indication of an accuracy level; or
an indication of a data labelling method.

The control request may be sent to a trusted data preparation configuration service. The control information may be received from a trusted or untrusted data preparation configuration service.

In an embodiment, there is provided a data preparation configuration service for controlling the data preparation performed by the data preparation service described herein.

The data preparation configuration service may be arranged to provide control information for use by the data preparation service. The control information may be for use in the data preparation performed by the data preparation service.

The data preparation configuration service may be arranged to perform one or more of the following:
installing, in the data preparation service, a method, algorithm, model, or function for performing the data preparation;
providing, for use by the data preparation service, e.g., via a meta language, a description of a method, algorithm, model, or function for performing the data preparation;
selecting, from a predefined list, a method, algorithm, model, or function for performing the data preparation, and indicating, to the data preparation service, the selected method, algorithm, model, or function;
indicating, to the data preparation service, an assisting tool (e.g., a digital twin) for assisting in the performance of the data preparation.

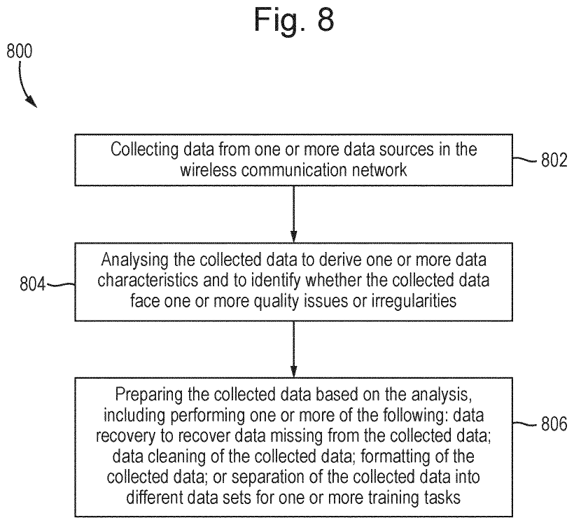

In an embodiment, there is provided a data preparation method performed in a wireless communication network. FIG. 8 is a process flow chart showing certain steps of this method 800. The method 800 comprises: collecting 802 data from one or more data sources in the wireless communication network; analysing 804 the collected data to derive one or more data characteristics and to identify whether the collected data face one or more quality issues or irregularities; and preparing 806 the collected data based on the analysis, including performing one or more of the following: data recovery to recover data missing from the collected data; data cleaning of the collected data; formatting of the collected data; or separation of the collected data into different data sets for one or more training tasks.

In an embodiment, there is provided a data preparation service (which may be data preparation software in a network cloud platform) in a wireless communication network. The data preparation service is capable of or configured to: receive, e.g., by a receiver, via a network automation and/or optimization tool (which may be, for example, an xApp or an rApp), configuration information from an application/service provider; and execute a configuration, e.g., by one or more processors, to control a data preparation process using the configuration information. The application/service provider may be a 3rd party provider, and may be the provider of the network automation and optimization tool.

There is provided a data preparation service in a wireless communication network. The data preparation service is arranged to: receive, via a network automation and/or optimization tool, configuration information from an application and/or service provider; and configure a data preparation process using the configuration information.

The data preparation service may be arranged to operate in an O-RAN system.

The network automation and/or optimization tool may be an xApp, which may be arranged to operate on a near-RT RIC. Alternatively, the network automation and/or optimization tool may be an rApp arranged to operate on a non-RT RIC.

The configuration information may be configured to perform one or more of: install, in the data preparation service, a method, algorithm, model, or function for performing the data preparation; provide, for use by the data preparation service, via a meta language, a description of a method, algorithm, model, or function for performing the data preparation; select or provide a selection of, from a predefined list, a method, algorithm, model, or function for performing the data preparation; and/or indicate, to the data preparation service, an assisting tool for assisting in the performance of the data preparation.

The configuration information may be configured to cause the use, by the data preparation service, when preparing the data, of an algorithm, model, mechanism, and/or tool. The algorithm, the model, the mechanism, and/or the tool used may depend on a particular analytics service, a particular mobile network service, a particular AI/ML model, a particular geographical area, or a particular set of users.

The configuration information may be configured to cause the data preparation service to collect data from one or more data sources in the wireless communication network.

The configuration information may be configured to cause the data preparation service to analyse data, e.g., the collected data, to derive one or more data characteristics and to identify whether the (e.g., collected) data face one or more quality issues or irregularities. Deriving one or more data characteristics may comprise determining one or more data characteristics selected from the group of characteristics consisting of: a central tendency of the (e.g., collected) data; a variation of the (e.g., collected) data; a relative effect among variables or features; and an amount of data adequate for a requested task. Identifying whether the (e.g., collected) data face one or more quality issues or irregularities may comprises identifying whether the collected data comprise one or more of the following: an anomaly; a missing value; irregular cardinality; or an outlier.

The configuration information may be configured to cause the data preparation service to prepare the collected data based on the analysis, including performing one or more of the following: data recovery to recover data missing from the (e.g., collected) data; data cleaning of the (e.g., collected) data; formatting of the (e.g., collected) data; labeling of the (e.g., collected) data; or separation of the (e.g., collected) data into different data sets for one or more training tasks.

The control information may specify one or more of the following: a type of data recovery and/or cleaning method to be implemented by the data preparation service; a type of data formatting that is to be used by the data preparation service to format the (e.g., collected) data; one or more data sources; how to separate the (e.g., collected) data into data sets; and/or how to label the data sets.

The data recovery may comprise one or more of the following: recovering missing data from a data source different to a data source from which the data was initially requested; replacing the missing data by other data; and/or augmenting existing data to account for the missing data.

The data cleaning may comprise executing a policy to mitigate against outliers and random errors from the collected data by removing data and/or introducing one or more weights to reduce the impact of outliers and random errors in the collected data.

The preparing the (e.g., collected) data may comprise determining an expected performance impact and/or a confidence level on an AI/ML model were the prepared data used as an input for said AI/ML model.

The formatting of the (e.g., collected) data comprises converting the collected data into an appropriate format used by an AI/ML model.

The labelling and/or separation of the collected data into different data sets for one or more training tasks may further comprise preparation of the data sets for inference, training, validation, and/or testing tasks.

The data preparation may provide labels to introduce a meaningful context from which the AI/ML model can learn.

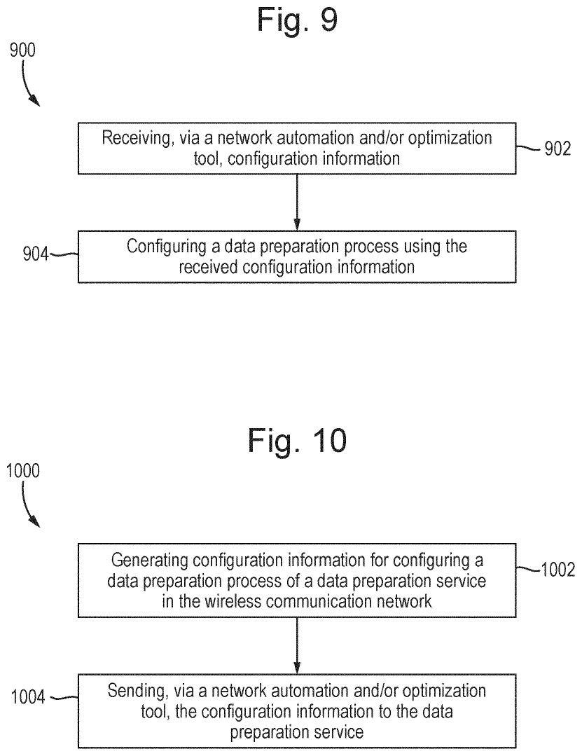

In an embodiment, there is provided a method performed by a data preparation service in a wireless communication network. FIG. 9 is a process flow chart showing certain steps of this method 900. The method 900 comprises: receiving 902, via a network automation and/or optimization tool, configuration information; and configuring 904 a data preparation process using the received configuration information.

In an embodiment, there is provided a service or application provider (which may be a 3rd party provider) in a wireless communication network. The service or application provider is capable of, arranged to, adapted to, allowed/permitted to, or configured to: generate, e.g., by one or more processors, configuration information for configuring a data preparation process of a data preparation service in the wireless communication network; and send, e.g., by a transmitter, via a network automation and/or optimization tool (which may be an xApp or an rApp), the configuration information to the data preparation service.

In an embodiment, there is provided a method performed by a service or application provider (which may be a 3rd party provider) in a wireless communication network. FIG. 10 is a process flow chart showing certain steps of this method 1000. The method 1000 comprises: generating 1002 configuration information for configuring a data preparation process of a data preparation service in the wireless communication network; and sending 1004, via a network automation and/or optimization tool, the configuration information to the data preparation service.

Data preparation is currently implementation specific based on pre-configuration. This fails to deal with certain problems, while limiting the flexibility when preparing vendor specific data. Existing solutions cannot support any interaction with 3rd party APPs in the O-RAN system. Hence, an analytics or service consumer (e.g., 3rd party) cannot typically control or get a data insight extracted by analysing the data or regarding data quality issues. Also, an analytics consumer cannot typically indicate how the data preparation needs to be performed to deal with missing data, data cleaning, processing, formatting, and labelling, nor suggest how to split data for training, validation, and testing.

The above-described apparatuses and methods advantageously tend to provide for data preparation that allows a flexible way to share and control the data preparation process by introducing xApps or rApps belonging to 3rd parties. Such apparatus defines: i) the DP configuration as an APP, ii) the interface that allows the configuration control, and iii) the mechanism that allows communication for the quality control reporting in data preparation.

Conventional solutions are implementation specific and so do not offer interaction with 3rd parties. Thus, conventionally, a consumer of analytics or an O-RAN service cannot influence the data preparation. As mentioned above, data preparation is a significant step for the performance of various services including analytics. The above-described apparatuses and methods advantageously tend to provide an open interface that allows parties to control the data preparation instead of relying on a preconfigured solution. This tends to achieve better analytics results. This tends to be especially useful for 3rd parties that tends to have good knowledge about their own data.

Embodiments described herein advantageously provide for data preparation, and the configuration of a data preparation via xApps and rApps.

Embodiments described herein provide for, in the O-RAN architecture: data preparation for RAN analytics exposure; data preparation for RRM/SON optimization; and rApp/SMO data preparation.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of O-RAN, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

Further aspects of the invention are provided by the subject matter of the following clauses:
Clause 1. An apparatus for data preparation where an xApp and/or rApp allows a 3rd party to perform monitoring and control related to the process of data preparation, by the means of (i) installing, or (ii) describing via meta language, or (iii) selecting out of a predefined list, or (iv) pointing to an assisting tool or sandbox that simulates an assisting method to accomplish this.
Clause 2. The apparatus of any preceding clause, where data quality issues can be regulated for a particular mobile network service, analytics service, AI/ML model, or for a specific application (e.g., for QoE). or geographical area, or users/UE(s), instructing the adoption of different algorithms/models, mechanisms, and tools to deal with data preparation.
Clause 3. The apparatus of any preceding clause, where a data processing APP can include at least one of the following operations i) select data sets, ii) analyse data for information extraction, iii) perform data exploration to identify data quality issue and irregularities, iv) data processing and formatting, and v) prepare data sets of training.
Clause 4. The apparatus of any preceding clause, where a data processing APP can include at least one of the following operations i) data recovery and cleaning, ii) simplifying data, iii) perform data formatting and iv) prepare the non-overlapping data sets for the purpose of training, including data labelling.
Clause 5. A method that allows a data analytics training service or another mobile network service to request data preparation that is performed and controlled with the assistance of a 3rd party.
Clause 6. A method that allows an analytics service or another mobile network service to request data preparation by indicating at least one of the following: mobile service type, analytics service type, time schedule, identifiers of the data sources, statistical properties of the expected data, expected processing of data, the preferred level of accuracy dealing with missing values and indicate the format of the prepared data.
Clause 7. A method that allows a data preparation control function to notify on the strategy dealing with missing data and other irregularities, provision or indication of the processing method, labelling of data and preparation of data sets.
Clause 8. A method that allows the data processing to provide a report to the data processing control including indication how it dealt with missing values, confidence in providing missing values, the policy adopted for outliers, the percentage of the data that is fixed by the suggestions, the labelling accuracy, and the timestamp.

The following abbreviations are relevant in the field addressed by this document:
3GPP 3rd Generation Partnership Project
5G 5th Generation of Mobile Communication
AI/ML Artificial Intelligence/Machine Learning
ADRF Analytical Data Repository Function
AF Application Function
AnLF Analytics Logical Function
CM Configuration Management
DCAF Data Collection Application Function
DCCF Data Collection Coordination Functionality
DP Data Preparation
KPI Key Performance Indicator
MF Management Function
MFAF Messaging Framework Adaptor Function
MICO Mobile Initiated Connection Only
MnS Management Service
MTLF Model Training Logical Function
NEF Network Exposure Function
NF Network Function
NRF Network Repository Function
NWDAF Network Data Analytics Function
OAM Operations, Administration and Maintenance
O-RAN Open RAN
PM Performance Measurement
QOE Quality of Experience
RAN Radio Access Network
SBA Service Based Architecture
UDM User Data manager
UDR User Data Repository
UE User Equipment

1. A data preparation service in a wireless communication network, comprising:
at least one memory; and
at least one processor coupled with the at least one memory and configured to cause the data preparation service to:
receive, via at least one of a network automation or optimization tool, configuration information from at least one of an application or service provider; and
configure a data preparation process using the configuration information.

2. The data preparation service of claim 1, wherein the data preparation service operates in a virtualized radio access network environment for application-based configuration of one or more service provider capabilities.

3. The data preparation service of claim 1, wherein the at least one of network automation or optimization tool is one of an xApp or an rApp related to an open radio access network (O-RAN) system.

3. (canceled)

4.-5. (canceled)

6. The data preparation service of claim 1, wherein, based at least in part on the configuration information, the at least one processor is configured to cause the data preparation service to collect data from one or more data sources in the wireless communication network.

7. The data preparation service of claim 1, wherein, based at least in part on the configuration information, the at least one processor is configured to cause the data preparation service to analyze collected data to derive one or more data characteristics and to identify whether the data includes one or more quality issues or irregularities.

8. The data preparation service of claim 7, wherein the at least one processor is configured to cause the data preparation service to derive the one or more data characteristics including at least one of of: a central tendency of the collected data; a variation of the collected data; a relative effect among variables or features; or an amount of the collected data being adequate for a requested task.

9. The data preparation service of claim 7, wherein the at least one processor is configured to cause the data preparation service to identify whether the data includes the one or more quality issues or irregularities based at least in part on whether the data includes one or more of an anomaly; a missing value; irregular cardinality; or an outlier.

10. The data preparation service of claim 1, wherein, based at least in part on the configuration information, the at least one processor is configured to cause the data preparation service to prepare and perform at least one of data recovery to recover data missing from the data; data cleaning of the data; formatting of the data; labeling of the data; or separation of the data into different data sets for one or more training tasks.

11. The data preparation service of claim 10, wherein the configuration information specifies one or more of:
at least one of a type of data recovery or a cleaning method to be implemented by the data preparation service;
a type of data formatting usable by the data preparation service to format the data;
one or more data sources;
how to separate the data into data sets; or
how to label the data sets.

12. The data preparation service of claim 10, wherein the data recovery comprises the at least one processor is configured to cause the data preparation service to one or more of:
recover missing data from a data source different than a data source from which the data was initially requested;
replace the missing data by other data; or
augment existing data to account for the missing data.

13. The data preparation service of claim 10, wherein the data cleaning comprises the at least one processor is configured to cause the data preparation service to execute a policy to mitigate against outliers and random errors from the data by at least one of removing data or introducing one or more weights to reduce an impact of the outliers and random errors in the collected data.

14. The data preparation service of any of claim 10, wherein the preparing the data comprises the at least one processor is configured to cause the data preparation service to determine at least one of an expected performance impact or a confidence level on an AI/ML model, wherein the prepared data is an input to the AI/ML model.

15.-16. (canceled)

17. A method performed by a data preparation service in a wireless communication network, the method comprising:
receiving, via a network automation and optimization tool, configuration information; and
configuring a data preparation process using the configuration information.

18. A network node for wireless communication, comprising:
at least one memory; and
at least one processor coupled with the at least one memory and configured to cause the network node to:
generate configuration information for configuring a data preparation process of a data preparation service in a wireless communication network; and
send, via at least one of a network automation or optimization tool, the configuration information to the data preparation service.

19. A method performed by a network node in a wireless communication network, the method comprising:
generating configuration information for configuring a data preparation process of a data preparation service in the wireless communication network; and
sending, via a network automation and optimization tool, the configuration information to the data preparation service.

20. The network node of claim 18, wherein the data preparation service is configured to operate in an open radio access network (O-RAN) system.

21. The network node of claim 18, wherein the at least one of network automation or optimization tool is one of an xApp or an rApp.

22. The network node of claim 18, wherein the at least one processor is configured to cause the network node to collect data from one or more data sources in the wireless communication network based at least in part on the configuration information of the data preparation process of the data preparation service.

23. The network node of claim 18, wherein the at least one processor is configured to cause the network node to send the configuration information to the data preparation service that is configured to analyze collected data for one or more data characteristics, the one or more data characteristics including a central tendency of the collected data, a variation of the collected data, a relative effect among variables or features of the collected data, or an amount of the collected data being adequate for a requested task.

24. The network node of claim 18, wherein the at least one processor is configured to cause the network node to send the configuration information to the data preparation service that is configured to analyze collected data for one or more of an anomaly, a missing value, irregular cardinality, or an outlier.
